(19) United States
(12) Patent Application Publication
(10) Pub. No.: US 2011/0123905 A1
(43) Pub. Date: May 26, 2011

(54) FUEL CONTAINER FOR FUEL CELL

(75) Inventors: Yasuaki Nakamura, Shizuoka (JP); Hideto Usui, Shizuoka (JP); Satoshi Komiyama, Shizuoka (JP); Mitsuo Hirotomi, Shizuoka (JP)

(73) Assignee: TOKAI CORPORATION, Tokyo (JP)

(21) Appl. No.: 11/996,957

(22) PCT Filed: Jul. 25, 2006
(86) PCT No.: PCT/JP2006/314699

§ 371 Date: Mar. 30, 2010

(30) Foreign Application Priority Data
Jul. 25, 2005 (JP) 2005-213652

(51) Int. Cl. H01M 8/02

(52) U.S. Cl. 429/515

(57) ABSTRACT

A fuel container for fuel cells is equipped with a container main body, containing liquid fuel therein to be supplied to a fuel cell, equipped with a connecting port, for connecting with the fuel cell or a pressure adjusting device, and extruding means, for extruding the liquid fuel. The fuel container is also equipped with a partitioning member, which is slidably provided within the container main body, for partitioning the interior of the container main body into a fuel storage chamber, in which the liquid fuel is contained, and an extruding means housing chamber, in which the extruding means is housed. The fuel container is further equipped with a valve provided in the connecting port, for enabling or preventing the flow of the liquid fuel. The frictional force generated at the surfaces of the connector main body and the partitioning member, which are in sliding contact, is 10N or less.

### BACKGROUND OF THE INVENTION

1. Field of the Invention

The present invention relates to a fuel container for fuel cells that houses liquid fuel for fuel cells, such as Direct Methanol Fuel Cells (DMFC's) and supplies the liquid fuel to the fuel cells. The present invention relates particularly to a partitioning member within the fuel container that partitions the liquid fuel and an extruding means for extruding the liquid fuel.

2. Description of the Related Art

Recently, the use of fuel cells in miniature portable terminals, such as laptop computers and Personal Digital Assistants (PDA's), is being considered. Fuel containers (fuel cartridges, for example) have been proposed as a means of supplying fuel to the fuel cells.

Liquid fuels, such as mixtures of purified water and methanol, and mixtures of purified water and ethanol, are considered as fuels to fill the fuel containers.

It is desired that fuel supply pumps, remaining fuel amount detecting mechanisms and the like are not provided in miniature portable apparatuses, due to restrictions regarding the sizes thereof, and from the viewpoint of improving power generating efficiency. At the same time, development of inexpensive, miniature and lightweight fuel containers is desired, in order to improve convenience and user-friendliness from users' standpoints. Further, it is desired for fuel containers to be reusable, not disposable, from the viewpoint of environmental conservation.

It is necessary for a partitioning member which functions as a piston to positively operate, in order to supply liquid fuel from a fuel container which is filled with the liquid fuel. It is necessary for the partitioning member to positively move, even under low pressure.

Therefore, the sliding properties of partitioning members are commonly improved, by forming a coating layer of Poly Tetra Fluoro Ethylene (PTFE) resin on the peripheral surfaces of partitioning members, to ensure that the partitioning members that function as pistons positively move.

Meanwhile, U.S. Pat. No. 4,808,453, Japanese Unexamined Patent Publication No. 2002-177364, and Japanese Unexamined Patent Publication No. 2002-291888 disclose techniques in which poly paraxylene resin is coated on pharmaceutical containers and partitioning members thereof.

However, the coating layers formed in the manner described above are generally sprayed onto the peripheral surfaces of the partitioning members. Therefore, unevenness occurs in the coating layers. The unevenness causes wrinkles to be generated in the coating layers following repeated use of the partitioning members, and there is a possibility that further use will peel the coating layers off. In the case that the coating layers are entirely peeled off, the sliding properties of the partitioning members are reduced, and the partitioning members cease to operate. In the case that the coating layers are partially peeled off, the partitioning members becomes inclined during operation, or the operation thereof becomes erratic. If these defects occur, there is a possibility that leaks and the like will occur, in addition to the operating defects of the partitioning members. If leaks occur, the durability of the partitioning members suffers, and the possible number of reuse of the fuel containers as a whole becomes limited. Note that the partitioning members move when a valve is opened and a fuel storage chamber is at a lower pressure than an extruding means housing chamber (compressed gas chamber). Therefore, the aforementioned leaks are highly likely to be the extruding means (compressed gas) leaking into the fuel storage chamber, which causes gas to be mixed into the liquid fuel. There is also a slight possibility of the liquid fuel leaking into the extruding means housing chamber. However, in this case, there is no danger, because the liquid fuel will not leak to the exterior of the fuel container, unless the main body of the container is damaged.

Generally, in the case that the coating layers are thick, the properties of the material of partitioning members cannot be fully taken advantage of. In the case that the coating layers are excessively thin, it is known that as the number of repeated uses increases, the probability that the coating layers will be peeled off due to friction increases. The film thickness of the coating layers formed in the aforementioned manner is approximately 20 μm, and it is difficult to form them to be any thinner.

In case the sliding properties of a partitioning member are poor, it becomes necessary to apply high pressure, in order to cause it to operate positively. Accordingly, the minimum internal pressure (the pressure within the extruding means housing chamber when the volume thereof is maximal) for completely extruding the liquid fuel from the fuel container needs to be set high. If the minimum internal pressure is set to be high, the maximum internal pressure (the pressure within the extruding means housing chamber when the volume thereof is minimal) also becomes high. In this case, the volume of the extruding means housing chamber needs to be enlarged, in order to reduce the difference in internal pressures as much as possible.

In addition, if the walls of the container main body are made thicker to increase the strength thereof, in order to be able to bear high pressures, the volume of the fuel storage chamber is decreased.

### SUMMARY OF THE INVENTION

The present invention has been developed in view of the foregoing circumstances. It is an object of the present invention to provide a fuel container for fuel cells that reduces failure rates, by securing positive sliding characteristics, sufficient durability, and sealing properties of a partitioning member, and also increases the possible number of repeated use and a volume ratio of fuel to be stored therein.

The fuel container for fuel cells of the present invention comprises:

a container main body equipped with a connecting port for connecting with a fuel cell or a pressure adjusting device, the container min body containing liquid fuel therein to be supplied to the fuel cell, and extruding means, for extruding the liquid fuel;

a partitioning member, which is slidably provided within the container main body, for partitioning the interior of the container main body into a fuel storage chamber, in which the liquid fuel is contained, and an extruding means housing chamber, in which the extruding means is housed; and

a valve provided in the connecting port, for enabling or preventing the flow of the liquid fuel;

the frictional force generated at the surfaces of the connector main body and the partitioning member which are in sliding contact being 10N or less.

A configuration may be adopted, wherein the fuel container for fuel cells comprises:

a cylindrical inner container that communicates with the connecting port, provided within the container main body.

A configuration may be adopted, wherein:

a coating layer having non-eluting properties with respect to the liquid fuel is provided on at least one of the surfaces of the connector main body and the partitioning member which are in sliding contact.

In the case that the coating layer is provided, it is preferable that:

the coating layer is constituted by a polyparaxylene resin.

In the case that the coating layer is provided, it is preferable that:

the film thickness of the coating layer is within a range of 0.2 μm to 3 μm.

In the case that the coating layer constituted by a polyparaxylene resin is provided, it is preferable that the polyparaxylene resin is a parylene N represented by the following chemical formula (I):

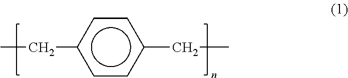

A configuration may be adopted wherein:

the partitioning member is constituted by a self lubricating rubber material.

A configuration may be adopted, wherein:

the extruding means is compressed gas; and

the extruding means housing chamber is a compressed gas chamber, in which the compressed gas is sealed.

The frictional force generated at the surfaces of a connector main body and a partitioning member, which are in sliding contact, of a fuel container for fuel cells having a structure as described above, is 10N or less. Therefore, the partitioning member can slide smoothly. If the sliding properties of the partitioning member are improved in this manner, the partitioning member is enabled to move with little pressure. Therefore, when the amount of fuel stored within a fuel storage chamber becomes low, the amount of pressure necessary to extrude the remaining fuel can be set low. That is, the internal pressure within an extruding means housing chamber when the volume of the extruding means housing chamber is maximal can be set low. By setting the internal pressure in this state to be low, the internal pressure of the extruding means housing chamber when the fuel storage chamber is filled to the maximum with fuel, that is, when the volume of the fuel storage chamber is maximal and the volume of the extruding means housing chamber is minimal, can also be set low. Therefore, the volume ratio of the fuel storage chamber with respect to the container main body can be set to be high. In addition, if the pressure is low, the need to form the walls of the container main body to be thick is obviated. Therefore, the volume of the container main body and the volume of the fuel storage chamber are not decreased. Accordingly, a greater amount of liquid fuel can be contained in the fuel container.

A coating layer constituted by a polyparaxylene resin having non-eluting properties with respect to the liquid fuel may be provided on at least one of the surfaces of the connector main body and the partitioning member which are in sliding contact. In this case, the coating layer may be formed without spraying, thereby decreasing the risk that the coating layer will be peeled off. Accordingly, the partitioning member can operate positively, without becoming inclined during movement, or the movement thereof becoming erratic. Therefore, the sliding properties of the partitioning member are improved, and failure rates are reduced, by securing positive sliding characteristics, sufficient durability, and sealing properties of the partitioning member. In addition, by reducing the failure rate, the possible number of repeated use increases.

The coating layer may be formed to have a film thickness within a range of 0.2 μm to 3 μm. In this case, the properties of the material of the partitioning member can be fully taken advantage of, due to the thinness of the coating layer, and leakage of the liquid fuel can be prevented.

### BRIEF DESCRIPTION OF THE DRAWINGS

FIG. 1 is a perspective view of a fuel container for fuel cells according to an embodiment of the present invention.

FIG. 2 is a sectional view taken along line II-II of FIG. 1.

FIG. 3 is a partial magnified view for explaining the connection between the fuel container for fuel cells of FIG. 1 and a pressure adjusting device.

FIG. 4 is an exploded perspective view of a pressure adjusting mechanism section of the pressure adjusting device of FIG. 3.

FIG. 5 is a graph that illustrates the relationship between the number of cycles and the sliding frictional force for Embodiment 1.

FIG. 6 is a graph that illustrates the relationship between the number of cycles and the sliding frictional force for Comparative Example 1.

FIG. 7 is a graph that illustrates the relationship between amount of time left standing and the sliding frictional force for Embodiment 2.

FIG. 8 is a graph that illustrates the relationship between amount of time left standing and the sliding frictional force for Comparative Example 2.

### DETAILED DESCRIPTION OF THE INVENTION

Hereinafter, a fuel container 1 for fuel cells (hereinafter, simply referred to as “fuel container 1”) according to an embodiment of the present invention will be described in detail with reference to the attached drawings. The fuel container 1 of the present embodiment stores liquid fuel, and supplies the liquid fuel to a DMFC within a portable terminal such as a laptop computer or a PDA, by being mounted within the portable terminal and connected to the DMFC via a pressure adjusting device.

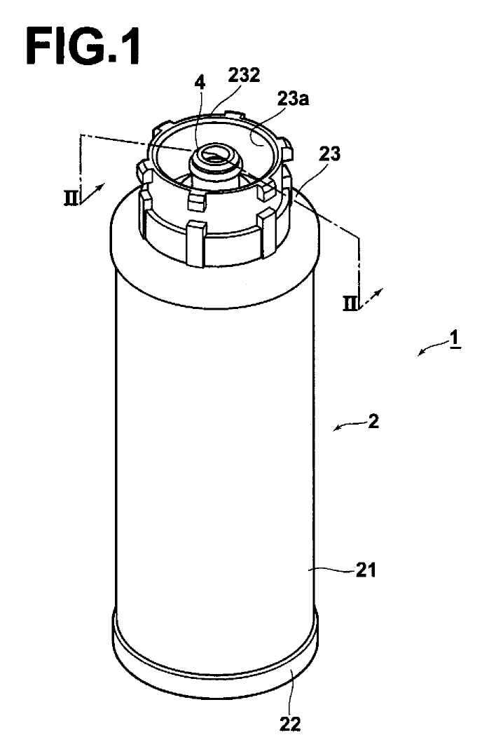

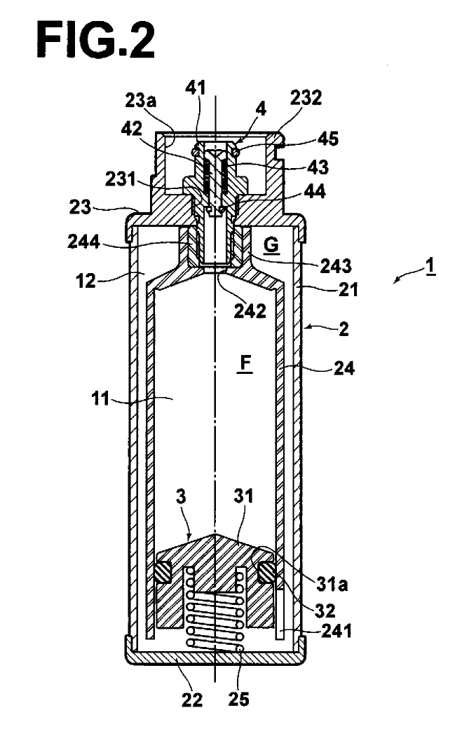

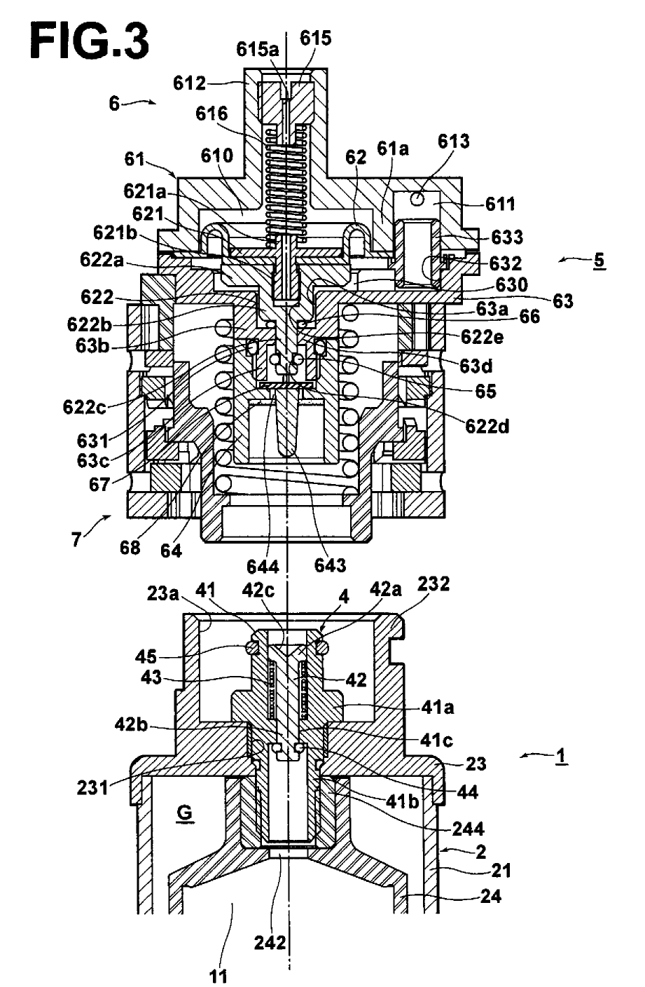

FIG. 1 is a perspective view of the fuel container 1 of the present embodiment. FIG. 2 is a sectional view taken along line II-II of FIG. 1. FIG. 3 is a partial magnified view for explaining the connection between the fuel container 1 of FIG. 1 and a pressure adjusting device to be described later. In the present embodiment, the side of the fuel container 1 having a connecting port for connecting to the pressure adjusting device will be referred to as the “upper side” (the upper side in FIG. 1) for the sake of convenience.

As illustrated in FIG. 1 and FIG. 2, the fuel container 1 houses liquid fuel F and compressed gas G, as extruding means for extruding the liquid fuel F, in its interior. The fuel container 1 comprises: a container main body 2 having a connecting port 23a, for connecting with a pressure adjusting device 5 to be described later, at the upper end thereof; a partitioning member 3, for partitioning the interior of the container main body 2 into a fuel storage chamber 11 that stores the liquid fuel F and an extruding means housing chamber that houses the compressed gas G, provided in the interior of the container main body 2 such that it is slidable therein; and a valve 4, for enabling or preventing the flow of the liquid fuel F stored in the container main body 2, provided in the connecting port 23a.

Note that in the present embodiment, the liquid fuel F is to be supplied to a DMFC. Therefore, the liquid fuel F is a mixture of purified water and methanol, or a mixture of purified water and ethanol. However, the present invention is not limited to storing these fuels, and the type of fuel to be stored in the fuel container 1 can be varied, according to the type of fuel cell, to which fuel is supplied.

In the present embodiment, it is preferable for the compressed gas G to be nitrogen gas, carbon dioxide gas, or deoxygenated air. These gases are preferred from the viewpoint of preventing oxygen, which may exert adverse influences to reactions of the liquid fuel F within the DMFC, from leaking into the liquid fuel F, and further to prevent oxidation of the liquid fuel F.

As illustrated in FIG. 1 and FIG. 2, the container main body 2 comprises: a substantially cylindrical outer container 21, which is open at the upper and lower ends thereof; a lid 22, which is removably mounted on the lower end of the outer container 21 and functions to seal the bottom thereof; a supply connecting member 23, which has the connecting port 23a at the approximate center thereof and is to be connected to the pressure adjusting device 5 to be described later (with reference to FIG. 3), mounted on the upper end of the outer container 21; and an inner container 24, which is provided within the outer container 21 to form a double container structure.

The fuel storage chamber 11, in which the liquid fuel is stored, formed within the inner container 24; a compressed gas chamber 12, in which the compressed gas G that generates pressure to extrude the liquid fuel F is contained, formed mainly between the outer surface of the inner container 24 and the inner surface of the outer container 21; the partitioning member 3 which functions as a piston, for partitioning the interior of the container main body 2 into the fuel storage chamber 11 and the compressed gas chamber 12, provided in the interior of the inner container 24 such that it is slidable vertically therein; and an elastic body 25, which is compressed between the partitioning member 3 and the bottom of the container main body 2 when the partitioning member 3 moves downward; are provided within the container main body 2. Note that the volume ratios of the fuel storage chamber 11 and the compressed gas chamber 12 vary depending on the position of the partitioning member. As the liquid fuel is consumed and the partitioning member 3 rises, a portion of the compressed gas chamber 12 is positioned within the inner container 24.

The inner container 24 is substantially cylindrical with an open bottom. The inner container 24 is provided within the outer container 21 such that it does not contact the lid 22. A plurality of vertically extending cutouts 241 are formed in the peripheral surface at the lower end of the inner container 24. The cutouts 241 enable the interior of the outer container 21 to communicate with the interior of the inner container 24 (this feature will be described in detail later) when the partitioning member 3 is moved downward and compresses the elastic body 25. An aperture 242 that communicates with the valve 4 to be described later is formed in the approximate center of the upper end of the inner container 24. Supply of the liquid fuel F stored within the fuel storage chamber 11 is enabled through the valve 4. An upwardly protruding cylindrical portion 243 is provided about the outer periphery of the aperture 242, and a nut 244 is provided within the cylindrical portion 243.

An insertion port 231, through which the valve is inserted, is formed at the approximate center of the lower end of the supply connecting member 23. An upwardly protruding connecting cylinder 232 is provided about the outer periphery of the insertion port 231, and the connecting port 23a for connecting with the pressure adjusting device 5 is provided at the upper end of the connecting cylinder 232. As illustrated in FIG. 1, outwardly directed protrusions that enable locking of connections with the pressure adjusting device 5 are provided on the outer peripheral surface of the distal end of the connecting cylinder 232. Note that the connection between the supply connecting member 23 and the pressure adjusting device 5 will be described later.

As illustrated in FIG. 3, the valve 4 comprises: a housing 41, which functions as a fixing member with respect to the supply connecting member 23 and as an engaging member with respect to a introducing member 64 to be described later; a stem 42 that moves according to a connected state with the pressure adjusting device 5; a spring 43 that urges the stem 42 in a closing direction; a valving element 44 (O-ring) that enables or prevents the flow of the liquid fuel F; and a connection sealing member 45 that functions as a seal when the supply connecting member 23 and the pressure adjusting device 5 are connected. The constituent parts of the valve 4 are preferably formed by non-metallic materials.

The housing 41 is substantially cylindrical in shape, and is equipped with: an outwardly protruding annular step 41a provided at an intermediate portion; a mounting cylinder 41b that extends downward from the lower surface of the annular step 41a; and an inwardly protruding annular step 41c, provided at an intermediate portion. The housing 41 is inserted through the insertion port 231 of the supply connecting member 23, and is arranged such that the lower surface of the annular step 41a abuts the upper edge of the insertion port 231. The housing 41 is mounted to the container main body 2 by the outer periphery of the mounting cylinder 41b being fastened by the nut 244 such that the lower end of the mounting cylinder 41b communicates with the aperture 242 of the inner container 242. The connection sealing member 45 is fitted about the outer periphery of the upper end of the housing 41.

The step 42 is formed as a rod, and is equipped with: an outwardly spreading large diameter portion 42a provided at the upper end; and a shaft portion 42b that extends downward from the large diameter portion 42a. A recess 42c, which the tip of a link protrusion 644 of the introducing member 64 of the pressure adjusting device 5 abuts, is formed in the approximate center of the upper surface of the large diameter portion 42a. The step 42 is inserted into the housing 41 such that it is movable in its axial direction. The spring 43 is provided between the lower surface of the large diameter portion 42a and the upper surface of the annular protrusion 41c, to urge the stem 42 upward. The tip of the shaft portion 42b of the stem 42 protrudes through an aperture formed at the interior of the annular protrusion 41c, and the valving element 44 (O-ring) mounted about the outer periphery of the tip of the shaft portion 42b press contacts against the lower end of the annular protrusion 41c, thereby sealing the aperture and preventing the flow of the liquid fuel F therethrough. When the recess 42c is pressed downward, the spring 43 compresses, the stem 42 moves downward, and the valving element 44 separates from the annular protrusion 41c to open the aperture, thereby enabling the flow of the liquid fuel F therethrough. The liquid fuel F passes through the gap formed between the shaft portion 42b and the annular protrusion 41c, and passes through the large diameter portion 42a and the housing 41, to be supplied to the pressure adjusting device 5.

Note that the valving element 44 of the valve 4 is the O-ring, which is elastic. The elastic valving element 44 is provided within a peripheral groove formed in the shaft portion 42b so as to regulate its position such that it does not swell or deform in the direction that the valve opens and closes (the axial direction of the stem 42). Therefore, even if the volume of the elastic valving element 44 that contacts the liquid fuel F increases due to swelling, the change in volume is regulated to be in a direction perpendicular to the direction that the valve opens and closes. Accordingly, such a change in volume does not affect the opening/closing operation of the valve 4, nor the flow of the liquid fuel F.

The partitioning member 3 comprises: a substantially cylindrical columnar main body 31 having a groove 31a formed in the outer peripheral surface thereof; and an elastic sealing member 32 (O-ring) formed of an elastic material such as rubber, which is fitted in the groove 31a. The outer periphery of the elastic sealing member 32 contacts the inner surface of the inner container 24 such that a hermetic seal is formed therewith. The partitioning member 3 is movable in the vertical direction within the inner container 24. The partitioning member 3 functions as a moving partition that partitions the interior of the container main body 2 such that the space that contacts the upper surface thereof becomes the fuel storage chamber 11, and the space that contacts the bottom surface thereof becomes the compressed gas chamber 12. The pressure exerted onto the bottom surface of the partitioning member 3 by the compressed gas G causes the partitioning member 3 to pressurize the liquid fuel F at its upper surface. The partitioning member operates to extrude the liquid fuel F when the stem 42 is operated to open the valve 4.

Here, the characteristic feature of the present invention is that a coating layer having non-eluting properties with respect to the liquid fuel F is provided on at least one of the surfaces of the container main body 2 and the partitioning member 3, which are in sliding contact with each other. In the present embodiment, the non-eluting coating layer is provided on the outer surface of the elastic sealing member 32.

The coating layer is formed by a material which has non-eluting properties with respect to the liquid fuel F. Therefore, there is no possibility that the coating layer will dissolve and contaminate the liquid fuel F.

Poly paraxylene resins are examples of the material of the coating layer, and parylene N is particularly preferred. The parylene N coating layer is formed by a CVD (Chemical Vapor Deposition) method, which enables coating at the molecular level, which is impossible with conventional liquid coating or powder coating methods. Therefore, it is possible to control the film thickness with high accuracy, and a uniform coating process can be administered without generating any pinholes. In this manner, the coating layer can be provided without spraying, and the possibility of the coating layer being peeled off can be reduced. Accordingly, the partitioning member 3 can operate positively, without becoming inclined during movement, or the movement thereof becoming erratic. Therefore, the sliding properties of the elastic sealing member 32 are improved, and failure rates are reduced, by securing positive sliding characteristics, sufficient durability, and sealing properties of the elastic sealing member 32. In addition, by reducing the failure rate, the possible number of repeated use increases.

Note that if the film thickness of the coating layer is less than a 0.2 μm, sufficient film strength cannot be obtained. If the film thickness of the coating layer exceeds 3 μm, the coating layer loses its elasticity, and will lose the advantages of the properties of the elastic material, such as being able to accommodate fine protrusions and recesses on the surface of the sealing member 32, thereby causing failures in the seal. Therefore, it is preferable for the film thickness of the coating layer to be within a range of 0.2 μm to 3 μm, in order to take sufficient advantage of the properties of the partitioning member 3, that is, the elastic sealing member 32. In this case, the properties of the material of the elastic sealing member 32 can be fully taken advantage of, due to the thinness of the coating layer, and leakage of the liquid fuel F can be prevented.

By providing the coating layer as described above, the frictional force generated at the surfaces of the connector main body 2 and the partitioning member 3, that is, the surfaces of the inner container 24 and the elastic sealing member 32, which are in sliding contact, becomes 10N or less.

Here, the frictional force being 10N or less means that the maximum force required to move the partitioning member 3 5 mm, when the partitioning member 3, in which the elastic sealing member 32 having the aforementioned coating layer is fitted on the main body 31, is provided within the inner container and the inner container 24 is filled with the liquid fuel F with the top thereof being open, is 10N or less. At this time, the inner container 24 is a PP molded container, the liquid fuel F is a mixture of purified water at 70% by weight and methanol at 30% by weight, the elastic sealing member 32 is a size P-11 EPDM O-ring, and the coating layer is a layer of parylene N having a film thickness of

The frictional force generated at the surfaces of the inner container 24 and the elastic sealing member 32, which are in sliding contact is 10N or less. Therefore, the partitioning member 3 can slide smoothly. If the sliding properties of the partitioning member 3 are improved in this manner, the partitioning member 3 is enabled to move with little pressure. Therefore, when the amount of liquid fuel F stored within the fuel storage chamber 11 becomes low, the amount of pressure necessary to extrude the remaining liquid fuel F can be set low. That is, the internal pressure within the compressed gas chamber 12 when the volume thereof is maximal can be set low. By setting the internal pressure in this state to be low, the internal pressure of the compressed gas chamber 12 when the fuel storage chamber 11 is filled to the maximum with the liquid fuel F, that is, when the volume of the fuel storage chamber 11 is maximal and the volume of the compressed gas chamber 12 is minimal, can also be set low. Therefore, the volume ratio of the fuel storage chamber 11 with respect to the container main body 2 can be set to be high. In addition, if the pressure is low, the need to form the walls of the container main body 2 to be thick is obviated. Therefore, the volume of the container main body 2 and the volume of the fuel storage chamber 11 are not decreased. Accordingly, a greater amount of the liquid fuel F can be contained in the fuel container 1.

In addition, the smooth sliding properties of the partitioning member 3 enables the liquid fuel F to be supplied smoothly in an initial state when no liquid fuel F is present within a DMFC, for example.

Note that in the present embodiment, the coating layer is provided on the outer surface of the elastic sealing member 32. However, the present invention is not limited to this configuration. Any configuration may be adopted, as long as the frictional force generated at the surfaces of the connector main body 2 and the partitioning member 3 which are in sliding contact becomes 10N or less. For example, the partitioning member 3 may be formed by a self-lubricating rubber material.

In addition, in the present embodiment, the non-eluting coating layer (the parylene N coating layer) is provided on the outer surface of the elastic sealing member 32. From the viewpoint of preventing elution of materials, it is preferable for all of the components of the fuel container 1 that comes into contact with the liquid fuel F to be provided with the coating layer. Particularly, it is preferable for the coating layer to be provided on rubber components, such as the valving element 44 which is mounted on the tip of the stem 42. By providing the coating layer, direct contact between the liquid fuel F and rubber components can be prevented. Therefore, rubber materials such as NBR and IR, which are less expensive than the conventional EPDM, may be utilized, and costs can be reduced.

It is preferable for the coating layer to be provided on the outer surface of the connection sealing member 45, which is fitted about the upper end of the valve 4, in order to improve the sliding properties thereof.

The fuel container 1 of the present embodiment is of a double container structure. However, the present invention is not limited to this configuration. The design can be changed as desired, and a single container structure may be adopted, for example.

Next, the charging of the compressed gas G into the compressed gas chamber 12 and the injection of the liquid fuel F will be described. Note that, the charging of the compressed gas G is performed prior to injecting the liquid fuel F.

First, a gas injecting port of a fueling device (not shown) is linked to the connecting port 23a, and the stem 42 is moved to its open position by a pressing operation. Then, the compressed gas G is injected into the fuel storage chamber 11 via the valve 4. Due to the injection of the compressed gas G, the partitioning member 3 moves downward from its natural resting position illustrated in FIG. 2. Further injection of the compressed gas G causes the partitioning member to compressively deform the elastic body 25 and move further toward the bottom of the container main body 2. In a state in which the partitioning member 3 is at its lowest position, the upper ends of the cutouts 241 are positioned above the elastic sealing member 32 of the partitioning member 3, and the compressed gas G is injected from the fuel storage chamber 11 into the compressed gas chamber 12 via the cutouts 241. When the interior pressure of the compressed gas chamber 12 reaches a predetermined level, injection of the compressed gas G is ceased.

Next, the stem 42 is moved to its open position again by a pressing operation, and the compressed gas G within the fuel storage chamber 11 is discharged. The partitioning member 3 rises due to the elastic force of the elastic body 25, and the state illustrated in FIG. 2, in which the fuel storage chamber 11 is sealed, is returned to. Accompanying further discharge of the compressed gas G, the pressure of the compressed gas G within the compressed gas chamber 12 presses the lower surface of the partitioning member 3, to cause it to rise to the upper end of the inner container 24. When all of the compressed gas G within the fuel storage chamber 11 is expelled, the compressed gas G is sealed within the compressed gas chamber 12. At this time, the amount of pressure within the compressed gas chamber 12 is not particularly restricted to any value, as long as the pressure is capable of extruding all of the liquid fuel F, which is to be injected into the fuel storage chamber 11 as will be described below. However, for the reasons stated above, lower pressure is preferred, and it is preferable for the pressure within the compressed gas chamber 12 to be 100 kPA or less.

Thereafter, an injecting means (not shown) is connected to the supply connecting member 23, and the liquid fuel F is injected into the fuel storage chamber 11 via the valve 4. The partitioning member 3 is lowered due to the injection of the liquid fuel F. The fuel container 1 is complete when a predetermined amount of the liquid fuel F is stored in the fuel storage chamber 11.

Next, the connection between and operation of the fuel container 1 and the pressure adjusting device 5 will be described. First, the pressure adjusting device 5 will be described. Note that for the sake of convenience, the side of the pressure adjusting device 5 that connects with the fuel container 1 will be referred to as the lower side thereof.

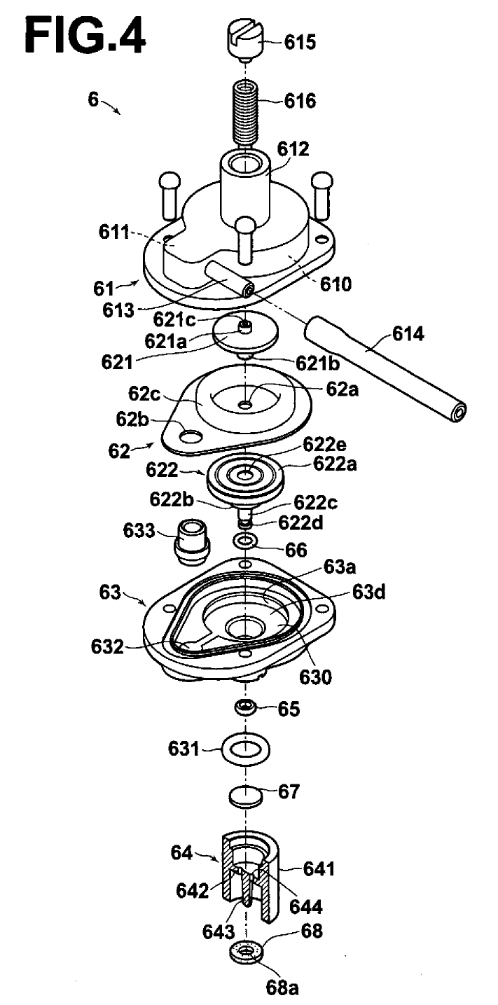

One end of the pressure adjusting device 5 is connected to the fuel container 1, and the other end thereof is connected to the DMFC (not shown). Thereby, the pressure adjusting device 5 adjusts the pressure of the liquid fuel F supplied thereto from the fuel container 1 to a predetermined pressure, then supplies the liquid fuel F to the DMFC. As illustrated in FIG. 3, the pressure adjusting device 5 comprises: a pressure adjusting mechanism section 6, equipped with a pressure adjusting mechanism (governor mechanism) for adjusting the pressure (primary pressure) of the liquid fuel F supplied from the fuel container 1 to a pressure (secondary pressure) at which the liquid fuel F is supplied to the DMFC; and a connector 7, which is engaged with the pressure adjusting mechanism section 6, and equipped with a fixing mechanism (ratcheting mechanism) for connecting with the supply connecting member 23 of the fuel container 1 in a locked state. FIG. 4 is an exploded perspective view of the pressure adjusting mechanism section 6.

As illustrated in FIG. 4, the pressure adjusting mechanism section 6 comprises: a case cover 61 and a case main body 63, which are arranged to face each other and house a diaphragm 62 therebetween; the introducing member 64, which is connected to the case main body 63 and into which the liquid fuel is introduced from the fuel container 1 at the primary pressure; an adjusting valve 65, which cooperates with the diaphragm 62 to reduce the primary pressure to the secondary pressure; a first check valve 66 (low pressure check valve) for preventing leakage of the liquid fuel F; a second check valve 67 (high pressure check valve) constituted by an elastic plate; and a filter 68 for preventing dust from entering the pressure adjusting mechanism section 6.

The case cover 61 and the case main body 63 are arranged vertically with the diaphragm 62 therebetween, and are engaged by screws, for example. Spaces are formed between the case cover 61 and the diaphragm 62 and between the case main body 63 and the diaphragm 62, respectively. The space toward the side of the case cover 61 is sectioned by an inner wall 61a that protrudes downward for the inner surface of the case cover 61 into: an atmospheric chamber 610 which is in communication with the atmosphere; and a fuel chamber 611, into which the liquid fuel F is introduced at the secondary pressure. The space toward the side of the case main body 63 is a pressure adjusting chamber 630, in which the liquid fuel F is stored after being depressurized to the secondary pressure.

A cylindrical portion 612 is provided to protrude from the upper surface of the case cover 61. An externally protruding cylindrical discharge section 613 is provided on the outer side wall of the case cover 61 that constitutes the fuel chamber 611. A pipe 614, for leading the liquid fuel F at the secondary pressure from the fuel chamber 611 to the DMFC (not shown), is removably attached to the tip of the discharge section 613.

A pressure adjusting screw 615 is threadedly engaged with the upper end of a pressure adjusting spring 616 such that the position of the pressure adjusting screw 615 is adjustable. The pressure adjusting spring 616 is provided within the cylindrical portion 612 substantially parallel to the axial direction thereof, such that the lower end of the pressure adjusting spring 616 abuts a supporter 621, to be described later. A vertically extending atmosphere communicating aperture 615a is formed through the approximate center of the pressure adjusting screw 615. The atmospheric chamber 610 communicates with the atmosphere via the atmosphere communicating aperture 615a. The pressure adjusting spring 616 expands and contracts corresponding to adjustments to the vertical position of the pressure adjusting screw 615. The predetermined secondary pressure is enabled to be adjusted by the pressure adjusting spring 616 adjusting the urging force against the diaphragm via the supporter 621.

The diaphragm 62 is elastic, substantially flat in shape, and comprises a large diameter portion and a small diameter portion. A supporter insertion aperture 62a, through which the supporter 621 is inserted, is formed at the approximate center of the large diameter portion. A cylindrical member insertion aperture 62b, through which a cylindrical member 632 to be described later is inserted, is formed at the approximate center of the small diameter portion. An upwardly protruding annular protrusion 62c is formed about the periphery of the supporter insertion aperture 62a. The supporter 621 is fixed to the upper side (toward the atmospheric chamber 610) of the diaphragm 62, and a shaft 622 to be described later is fixed to the lower side (toward the pressure adjusting chamber 630) of the diaphragm 62. The supporter 621 and the shaft 622 are configured to be movable in the vertical direction (the axial direction) integrally with the diaphragm 62, corresponding to elastic displacement thereof.

The supporter 621 is a flat disc with the lower surface thereof being fixed to the diaphragm 62, and the upper surface thereof abutting the aforementioned pressure adjusting spring 616. A shaft 621a, which is insertable into the pressure adjusting spring 616, is formed at the center of the upper surface of the supporter 621. A downwardly protruding bolt 621b, which is inserted through the supporter insertion aperture 61a and fastened to the shaft 622, is provided on the lower surface of the supporter 621. A vertically extending aperture 621c is formed at the approximate center of the supporter 621. The upper end of the aperture 621 is in communication with the atmospheric chamber 610.

The shaft 622 comprises: a substantially discoid large diameter boss portion 622a, of which the upper surface is fixed to the lower surface of the diaphragm 62; a substantially cylindrical columnar small diameter boss portion 622b, formed at the center of the lower end of the large diameter boss portion 622a; and a boss shaft portion 622c, which extends downward from the center of the lower end of the small diameter boss portion 622b. A peripheral groove 622d, into which the adjusting valve 65 is fitted, is formed in the lower end of the boss shaft portion 622c, and the first check valve 66 is fitted about the periphery of the upper end of the boss shaft portion 622c. A fastening hole 622e, for fastening the bolt 621b, is provided in the upper surface of the shaft 622, down to a predetermined position of the small diameter boss portion 622b.

Note that the diaphragm 62 receives the secondary pressure of the liquid fuel F, which is stored in the pressure adjusting chamber 630, from below, and atmospheric pressure of gas within the atmospheric chamber 610, from above. The diaphragm is capable of elastic displacement in the vertical direction corresponding to pressure differences between the secondary pressure and atmospheric pressure. The diaphragm 62 is maintained at a position at which the urging force generated by the atmospheric difference and the urging force exerted by the pressure adjusting spring 616 are at an equilibrium.

The case main body 63 is substantially a box having an open top. An opening 63a, through which the small diameter boss portion 622b is inserted, is formed in the inner surface of the case main body 63. A downwardly protruding large diameter cylindrical portion 63b, of which the upper end communicates with the opening 63a, is formed about the periphery of the opening 63a. A downwardly protruding cylindrical portion 63c having an open lower end is formed on the lower surface of the large diameter cylindrical portion 63b. A groove is formed about the periphery of the upper end of the cylindrical portion 63c. An introducing O-ring 631 of the introducing member 64 is fitted in the groove.

An annular partition wall 63d is formed on the inner surface of an aperture at the boundary between the large diameter cylindrical portion 63b and the cylindrical portion 63c. The boss shaft portion 622c is configured to be slidably inserted through the aperture formed by the partition wall 63d. The first check valve 66 and the adjusting valve 65 abut or separate from the upper surface of the partition wall 63c and the lower surface of the partition wall 63c, as the boss shaft portion 622c moves in the vertical direction (the axial direction) corresponding to the elastic displacement of the diaphragm 62. Thereby, the flow of the liquid fuel F is enabled or prevented (this mechanism will be described in detail later).

Further, a cylindrical member housing chamber 632 that communicates with the cylindrical member insertion aperture 62b of the diaphragm 62 is provided in the inner surface of the case main body 63. A cylindrical member 633 is housed within the cylindrical member housing chamber 632. The cylindrical member 633 is open at both ends, and is provided such that the lower end thereof does not contact the inner surface of the cylindrical member housing chamber 632, and such that the upper end thereof is positioned in the fuel chamber 611. The cylindrical member 633 functions to introduce the liquid fuel F, which has been adjusted to the secondary pressure, into the fuel chamber 611.

The upper surface of the introducing member 64 is connected to the lower surface of the large diameter cylindrical portion 63b of the case main body 63. The introducing member 64 comprises: a cylinder main body 641 having a groove that engages with the introducing O-ring 631; a partition wall 642 which is provided on the inner surface of the cylinder main body 641 at a predetermined distance from the upper end thereof; the downwardly protruding linking protrusion 643, which is formed at the approximate center of the lower surface of the partition wall 642, for abutting the recess 42c of the stem 42; and apertures 644 that pass through the partition wall 642 on both sides of the linking protrusion 643.

When the pressure adjusting device 5 is connected to the fuel container 1, the linking protrusion 643 abuts the recess 42c and presses it downward, to cause the stem 42 to perform an opening operation. The linking protrusion 643 is fixed to the partition wall 642, and is a structure separate from the boss shaft portion 622c which cooperates with the diaphragm 62. Thereby, the downward pressing operation of the linking protrusion 643 does not exert force on the diaphragm 62. That is, when the linking protrusion 643 presses the stem 42 downward maximally (maximally depressed state), the spring 43 is held in a compressed state. Therefore, the linking protrusion 643 is urged upward by the spring 43. The linking protrusion 643 and the boss shaft portion 622c which cooperates with the diaphragm 62 are configured as separate structures such that the urging force does not displace the diaphragm 62, thereby impeding the pressure adjusting function thereof.

The second check valve 67, constituted by a rubber plate, a sandwich plate or the like for sealing the apertures 644, is provided on the upper surface of the partition wall 642.

The second check valve 67 functions as a check valve that prevents backflow of the liquid fuel F by sealing the apertures 644 with the secondary pressure, when supply of the liquid fuel form the fuel container 1 is ceased (when the fuel container 1 is disconnected from the pressure adjusting device 5) while the secondary pressure within the pressure adjusting chamber 630 is high. The second check valve 67 prevents leakage of the liquid fuel F to the exterior. If the secondary pressure is low at this time, sufficient force may not be exerted on the second check valve 67 to seal the apertures 644, due to the elasticity of the second check valve 67. If the apertures 644 are not sealed, there is a possibility that the liquid fuel F will leak to the exterior. Accordingly, when the secondary pressure is low, the first check valve 66 abuts the upper surface of the partition wall 63d, thereby preventing the backflow of the liquid fuel F.

The filter 68 is provided on the lower surface of the partition wall 642 to remove contaminants, such as dust, from the liquid fuel F supplied from the fuel container 1 at the primary pressure. The filter 68 is a disc having an aperture 68a at the approximate center thereof. The outer diameter of the filter 68 is slightly greater than the outer diameter of the partition wall 642, that is, the inner diameter of the cylinder main body 641. The inner diameter of the aperture 68a is slightly smaller than the outer diameter of the upper end, that is, the base portion, of the linking protrusion 643. By forming the filter 68 to have these dimensions, the filter 68 is prevented from dropping when inserted and mounted into the introducing member 64 from below.

The material of the filter 68 is Low Density Poly Ethylene (LDPE) foam, having a void ratio of 85%, a mean cell diameter of 30 μm, and a thickness of 1 mm, for example. The material of the foam is at least one of: polyethylene; polypropylene; polyoxymethylene; polyethylene terephthalate; polyethylene naphthalate; and polyacrylonitrile.

By providing the filter 68, fine particles which are present within the liquid fuel F at the primary pressure can be prevented from entering the interior of the pressure adjusting mechanism section 6. Thereby, failures in operation of the operative parts of the pressure adjusting mechanism section 6 are prevented.

Note that the internal components of the pressure adjusting mechanism section 6 of the present embodiment are exposed to the liquid fuel F for long amounts of time. Therefore, it is preferable for all of the components of the pressure adjusting mechanism section 6 that come into contact with the liquid fuel F to be provided with the aforementioned coating layer. Particularly, it is preferable for the coating layer to be provided on rubber components. By providing the coating layer, direct contact between the liquid fuel F and rubber components can be prevented. Therefore, rubber materials such as NBR and IR, which are less expensive than the conventional EPDM, may be utilized, and costs can be reduced.

The pressure adjusting mechanism section 6 is configured as described above. Next, the connector 7 will be described.

The connector 7 is substantially cylindrical. One end of the connector 7 is fixed to the pressure adjusting mechanism section 6, and the other end is removably mounted onto the supply connecting member 23 of the fuel container 1. The connector 7 is configured to engage with the protrusions which are provided on the outer periphery of the supply connecting member 23 when the linking protrusion 643 holds the stem 42 in the maximally depressed state, to lock the connection between the connector 7 and the fuel container 1 by the ratcheting mechanism. The fuel container 1 comprises a mechanism that releases the depressed state, to easily separate from the pressure adjusting mechanism section 6.

Note that the connector 7 of the present embodiment utilizes the ratcheting mechanism to lock the connection between it and the fuel container 1. However, the present invention is not limited to this configuration. Any configuration may be adopted, as long as the fuel container 1 is capable of holding the depressed state and is of a structure that enables easy disengagement from the pressure adjusting mechanism section 6. The connector 7 is of the same structure as the connector disclosed in Japanese Patent Application No. 2004-266463. Therefore, a detailed description thereof will be omitted.

The pressure adjusting device 5 is configured as described above. Next, the connection between and operation of the fuel container 1 and the pressure adjusting device 5 will be described.

First, the pressure adjusting device 5 is connected to and locked with the fuel container 1. The introducing member 64 at the lower end of the pressure adjusting mechanism section 6 is inserted into the connecting port 23a at the upper end of the fuel container 1. At this time, the outer surface of the connection sealing member 45 press contacts against the inner surface of the introducing member 64, thereby securing a sealed state between the valve 4 and the introducing member 64. Further, the linking protrusion 643 abuts the recess 42c of the stem 42, and presses the stem 42 downward to its lowest position. Thereby, the liquid fuel F is supplied from the fuel container 1 to the pressure adjusting mechanism section 6 at the primary pressure as described above. In this state, the fuel container 1 is fixed to the pressure adjusting mechanism section 6 by the connector 7.

Note that no pressure is applied to the pressure adjusting mechanism section 6 from below (from the side that the primary pressure is applied) when the fuel container 1 is not connected thereto. Therefore, the adjusting valve 65 is separated from the partition wall 63, that is, in an open state, as illustrated in FIG. 3.

The liquid fuel F supplied from the fuel container 1 at the primary pressure passes through the filter 68, and passes through the apertures 644 in a state in which contaminants such as dust are removed therefrom. The liquid fuel F presses the second check valve 67 upward with the primary pressure and rises through the space between the inner aperture of the partition wall 63d and the boss shaft portion 622c, which has been opened by the adjusting valve 65, and is stored in the pressure adjusting chamber 630.

Here, the pressure adjusting mechanism that adjusts the primary pressure of the liquid fuel F into the secondary pressure will be described in detail.

First, as described previously, the vertical position of the pressure adjusting screw 615 is adjusted, to set a predetermined secondary pressure. For example, if the position of the pressure adjusting screw 615 is adjusted downward in order to increase the set pressure, the pressure adjusting spring 616 is compressed, and a downwardly urging force is applied to the diaphragm 62. The diaphragm 62 is displaced downward, and the shaft 622 also moves downward accompanying the displacement of the diaphragm 62. Therefore, the adjusting valve 65, which is mounted on the lower end of the boss shaft portion 622c of the shaft 622, separates from the partition wall 63 in an opening operation. Thereby, the liquid fuel F flows into the pressure adjusting chamber 630 from the primary pressure side, and the upwardly directed pressure (secondary pressure) thereof is applied to the diaphragm 62.

As the secondary pressure increases and the upwardly directed force applied to the lower surface of the diaphragm 62 increases the diaphragm 62 is displaced upward, and compresses the pressure adjusting spring 616 via the supporter 621. The diaphragm 62 is maintained at a position at which the downwardly directed urging force generated by the pressure adjusting spring 616 and the upwardly directed urging force exerted on the lower surface of the diaphragm 62 are at an equilibrium. A desired secondary pressure is set in this manner.

In addition, when the liquid fuel F is expelled from the pressure adjusting chamber 630 or the primary pressure varies, thereby decreasing the secondary pressure, the upwardly directed urging force applied to the lower surface of the diaphragm 62 decreases. Therefore, the diaphragm 62 is displaced downward by the downwardly directed urging force of the pressure adjusting spring 616. The shaft 622 also moves downward accompanying the displacement of the diaphragm 62. Therefore, the adjusting valve 65, which is mounted on the lower end of the boss shaft portion 622c of the shaft 622, separates from the partition wall 63 in an opening operation. Thereby, the liquid fuel F flows into the pressure adjusting chamber 630 from the primary pressure side, and secondary pressure is maintained at its set value.

In contrast, if expulsion of the liquid fuel form the pressure adjusting chamber 630 is ceased or the primary pressure varies, thereby increasing the secondary pressure, the upwardly directed urging force applied to the lower surface of the diaphragm 62 increases, and the diaphragm 62 is displaced upward. The shaft 622 also moves upward accompanying the displacement of the diaphragm. Therefore, the adjusting valve 65, which is mounted on the lower end of the boss shaft portion 622c of the shaft 622, abuts the partition wall 63 in a closing operation. Thereby, the liquid fuel F is prevented from flowing into the pressure adjusting chamber 630 from the primary pressure side, and secondary pressure is maintained at its set value.

Note that during the pressure adjustment described above, the first check valve 66 performs opening and closing operations opposite those of the adjusting valve 65 which accompanies the vertical displacement of the shaft 622. That is, the adjusting valve 65 performs an opening operation (separates from the lower surface of the partition wall 63d) accompanying downward movement of the shaft 622, whereas the first check valve performs a closing operation (approaches the upper surface of the partition wall 63d). Conversely, the adjusting valve 65 performs a closing operation (approaches the lower surface of the partition wall 63d) accompanying upward movement of the shaft 622, whereas the first check valve performs an opening operation (separates from the upper surface of the partition wall 63d). In other words, the pressure adjusting properties with respect to the primary pressure are inverse between the adjusting valve 65 and the first check valve 66.

In addition, pressure loss is exerted on the diaphragm 62 (the shaft 622) by the primary pressure operating on the projected area of the adjusting valve 65. Therefore, a margin of error in the adjustment of the secondary pressure generated by variance in pressure loss corresponding to variance in the primary pressure is compensated for by the combination of the pressure adjusting properties of the adjusting valve 65 and the first check valve 66, to uniformize the secondary pressure.

Further, the opposite opening and closing operations of the adjusting valve 65 and the first check valve 66 with respect to displacement of the diaphragm 62 also relieve pressure adjustment variations due to errors in the mounting positions thereof. Thereby, accuracy during manufacture becomes less stringent, and manufacture is facilitated.

The liquid fuel F is accurately adjusted to the secondary pressure by the pressure adjusting mechanism, then introduced into the fuel chamber 611 via the cylindrical member 633. The liquid fuel F further passes through the discharge section 613 and is supplied to the DMFC via the pipe 614.

The present embodiment utilizes the pressure adjusting device 5 having the configuration described above. However, the present invention is not limited to this configuration. Any type of pressure adjusting device may be utilized, as long as it is capable of supplying liquid fuel F to the DMFC at a predetermined secondary pressure.

Note that U.S. Pat. No. 4,808,453, Japanese Unexamined Patent Publication No. 2002-177364, and Japanese Unexamined Patent Publication No. 2002-291888, that disclose techniques in which poly paraxylene resin is coated on pharmaceutical containers and partitioning members thereof, describe elution from the components thereof, adsorption of the components of the pharmaceutical containers, and improvements in sliding properties as their objectives.

However, regarding the sliding properties, in the pharmaceutical containers disclosed by the aforementioned documents, sliding members are caused to slide either by hand or by machines over a short period of time. In contrast, in the fuel container of the present invention, the partitioning member is caused to slide by compressed gas, liquefied gas, springs and the like, over several hours to several days. In addition, in the fuel container of the present invention, the partitioning member is not constantly in motion, but rather moves and stops cyclically. Accordingly, it is necessary for the sliding properties to be constantly stable. To this end, the sliding frictional force needs to be stable at low values.

Further, the fuel container of the present invention also differs from the pharmaceutical containers in that it is repeatedly recycled and reused.

The objective of improving the sliding properties in the present invention is to decrease failure rates, while increasing the number of possible repeated use and the volume ratio of fuel. Therefore, the present invention would not have been easily conceived of, based on the aforementioned documents.

Next, the fuel container for fuel cells of the present invention will be described with reference to concrete examples.

### Embodiment 1

An endurance test was performed, utilizing the inner container 24, the partitioning member 3 (main body 31 and the O-ring 32), and the valve 4 as described in the above embodiment. The inner container 24 and the main body 31 were molded from PP, the O-ring was molded from EPDM, with a coating layer of parylene N having a film thickness of 1 μm.

1) First, the partitioning member 3 was positioned at the topmost portion of the inner container 24. The valve 4 was mounted into the aperture 242, and 2 ml of pure methanol was injected into the inner container 24. Thereafter, the partitioning member 3 was pressed from below, to expel the pure methanol via the valve 4. This operation was repeated twice, to expel gas from within the inner container 24.

2) Next, 6 ml of a mixture of purified water at 70% by weight and methanol at 30% by weight was injected into the inner container 24 via the valve 4.

3) After injection, the valve 4 was removed. Then, the partitioning member 3 was pressed from below while the upper portion of the inner container 24 was in an open state, and the partitioning member 3 was moved upward 5 mm. At this time, the pressure applied to the partitioning member 3 was measured by a high accuracy tensile/compressive load measuring device (TCLZ-100NA, by Tokyo Measurement Instrument Laboratories). The maximum observed pressure was designated as the measured value. The measured value was designated as the frictional force generated at the surfaces of the inner connector 24 and the partitioning member 3 which are in sliding contact.

4) After measurement, all of the 30% by weight methanol solution remaining in the inner container 24 was expelled.

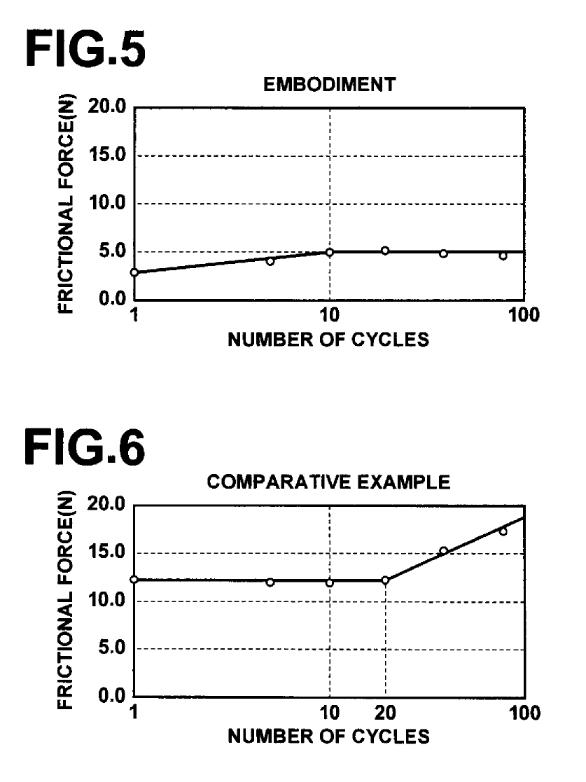

The above steps 1 through 4 were designated as a single cycle. 80 cycles of the steps were performed. The results are illustrated in FIG. 5.

### Comparative Example 1

In order to obtain results to compare against those obtained by Embodiment 1, Comparative Example 1 had the same structure except that a PTFE coating layer having a film thickness of 20 μm was provided on an O-ring molded from EPDM. The same endurance test was performed on Comparative Example 1. The results are illustrated in FIG. 6.

FIG. 5 is a graph that illustrates the relationship between the number of cycles and the sliding frictional force when the parylene N coating layer is provided on the outer surface of the O-ring. According to the graph, the sliding frictional force was 5N or less up to 10 cycles. Beyond 10 cycles, the sliding frictional force was stable at about 5N.

FIG. 6 is a graph that illustrates the relationship between the number of cycles and the sliding frictional force when the PTFE coating layer is provided on the outer surface of the O-ring. According to the graph, the sliding frictional force was stable at about 12N up to 20 cycles. Beyond 20 cycles, the sliding frictional force increased with each cycle.

As is clear from FIG. 5 and FIG. 6, in the case that the PTFE coating layer was provided on the outer surface of the O-ring, the value of the sliding frictional force increased with each cycle beyond 20 cycles. This suggests that at least a portion of the PTFE coating layer had peeled off. In contrast, in the case that the parylene N coating layer was provided on the outer surface of the O-ring, the value of the sliding frictional force remained stable at less than 10N even when the number of cycles increased. This suggests that the parylene N coating layer had not peeled off. Accordingly, by providing the parylene N coating layer on the outer surface of the O-ring, the sliding frictional force generated at the surfaces of the inner container and the O-ring which are in sliding contact remained stable at less than 10N even when the number of cycles increased, and the partitioning member was enabled to slide smoothly.

### Embodiment 2

The same fuel container as that of Embodiment 1 was utilized to perform a test of deterioration over time. The testing method comprised steps 1 and 2 of the durability test above. Thereafter, the fuel container was left to stand in a 65° C. environment for a predetermined amount of time, at which point step 3 was performed.

5) After the value of frictional force was measured, the valve 4 was replaced, and the 30% methanol by weight solution was injected into the inner container 24 via the valve 4, thereby returning the fuel container to a state after step 2 of the durability test. Thereafter, the fuel container was left to stand in a 65° C. environment again for a predetermined amount of time, at which point step 3 was performed.

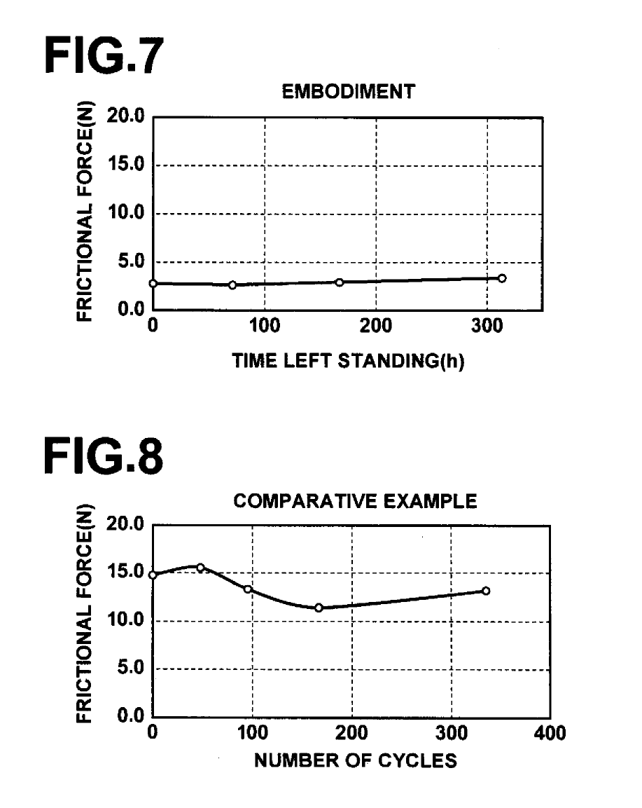

Step 5 was repeatedly performed, to measure changes in the sliding frictional force with the passage of time that the fuel container was left standing in the 65° C. environment. Note that the “Time Left Standing” in this test refers to the cumulative amount of time that the fuel container was left standing in the 65° C. environment, and does not include the time required for measurement. The results are illustrated in FIG. 7.

### Comparative Example 2

In order to obtain results to compare against those obtained by Embodiment 2, Comparative Example 2 had the same structure except that a PTFE coating layer having a film thickness of 20 μm was provided on an O-ring molded from EPDM. The same test of deterioration over time was performed on Comparative Example 2. The results are illustrated in FIG. 8.

FIG. 7 is a graph that illustrates the relationship between amount of time left standing and the sliding frictional force when the parylene N coating layer is provided on the outer surface of the O-ring. According to the graph, the sliding frictional force was stable within a range of approximately 2.5N to 3.0N over time.

FIG. 8 is a graph that illustrates the relationship between amount of time left standing and the sliding frictional force when the PTFE N coating layer is provided on the outer surface of the O-ring. According to the graph, the sliding frictional force was approximately 15N but slightly increasing up to 50 hours left standing. The sliding frictional force decrease approximately 5N between 50 hours and 165 hours left standing. However, the sliding frictional force was never 10 N or less, and began a gradual increase when the time left standing exceeded 165 hours.

As is clear from FIG. 7 and FIG. 8, in the case that the PTFE coating layer was provided on the outer surface of the O-ring, the value of the sliding frictional force was constantly greater than 10N regardless of the amount of time left standing, and was not stable. This may be due to swelling of the PTFE coating layer itself, the 30% by weight methanol solution passing through the PTFE coating layer, or peeling off of the PTFE coating layer, which resulted in the 30% by weight methanol solution coming into contact with the O-ring (rubber member) thereby causing swelling of the O-ring itself.

In contrast, in the case that the parylene N coating layer was provided on the outer surface of the O-ring, the value of the sliding frictional force remained stable at approximately 2.5N to 3.0N over the passage of time left standing. Accordingly, it can be considered that the O-ring having the parylene N coating layer on its outer surface does not elute or deteriorate by swelling, even if it is in contact with the 30% by weight methanol solution. Constantly stable sliding properties were able to be secured even if the O-ring was in contact with the solution over a long period of time.

### Embodiment 3

The same fuel container as that of Embodiment 1 was utilized to perform a test of seal failure. The testing method comprised steps 1 and 2 of the durability test above. Then, the 30% by weight methanol solution was caused to flow out via the valve at a rate of 6 ml/60-120 min. Thereafter, the number of fuel containers in which gas had entered due to seal failure of the O-ring was counted.

### Comparative Example 3

In order to obtain results to compare against those obtained by Embodiment 3, Comparative Example 3 had the same structure except that a PTFE coating layer having a film thickness of 20 μm was provided on an O-ring molded from EPDM. The same test seal failure was performed on Comparative Example 3.

The test results for Embodiment 3 and Comparative Example 3 are illustrated in Table 1.

TABLE 1

| O-ring | No. of Samples | No. of Failures | Failure Rate |
|---|---|---|---|
| Parylene N | 150 | 0 | 0% |
| PTFE | 150 | 15 | 10% |

A χ² verification by an m×n contingency table was performed, in order to verify whether there are any differences in the probabilities of occurrence of failures between O-rings provided with the parylene N coating layer and O-rings provided with the PTFE coating layer. Table 2 illustrates the test results of Table 1 fitted into a 2×2 contingency table.

TABLE 2

| O-ring | No. of Passes B₁ | | No. of Failures B₂ | | Total | |
|---|---|---|---|---|---|---|
| Parylene N A₁ | 150 | a | 0 | b | 150 | g |
| PTFE A₂ | 135 | c | 15 | d | 150 | h |
| Total | 285 | e | 15 | f | 300 | n |

Commonly, χ² is calculated by the following formula in a 2×2 contingency table.

$${χ}^{2} = \frac{{( ad - bc )}^{2} n}{efgh}$$

If the values illustrated in Table 2 are substituted into the above formula to derive the value of χ², χ²=15.789. This value is greater than χ² a point within a commonly used χ² distribution table having a degree of freedom 1 and a level of significance 0.01, that is, χ²(1, 0.01)=6.635. Therefore, it can be said that there is a difference between the probabilities of occurrence of failures between O-rings provided with the parylene N coating layer and O-rings provided with the PTFE coating layer, with a percentage of risk of 1%.

Accordingly, it can be said that probability of occurrence of failures is lower for O-rings provided with the parylene N coating layer that that for O-rings provided with the PTFE coating layer.

What is claimed is:

1. A fuel container for fuel cells, comprising:
a container main body equipped with a connecting port for connecting with a fuel cell or a pressure adjusting device, the container main body containing liquid fuel therein to be supplied to the fuel cell, and extruding means, for extruding the liquid fuel;
a partitioning member, which is slidably provided within the container main body, for partitioning the interior of the container main body into a fuel storage chamber, in which the liquid fuel is contained, and an extruding means housing chamber, in which the extruding means is housed; and
a valve provided in the connecting port, for enabling or preventing the flow of the liquid fuel;
the frictional force generated at the surfaces of the connector main body and the partitioning member which are in sliding contact being 10N or less.

2. (canceled)

3. A fuel container for fuel cells as defined in claim 1, wherein:
a coating layer having non-eluting properties with respect to the liquid fuel is provided on at least one of the surfaces of the connector main body and the partitioning member which are in, sliding contact.

4. A fuel container for fuel cells as defined in claim 3, wherein:
the coating layer is constituted by a polyparaxylene resin.

5. A fuel container for fuel cells as defined in claim 4, wherein:
the film thickness of the coating layer is within a range of 0.2 μm to 3 μm.

6. A fuel container for fuel cells as defined in claim 4, wherein the polyparaxylene resin is a parylene N represented by the following chemical formula (I):

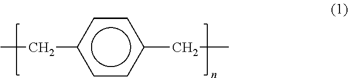

7. A fuel container for fuel cells as defined in claim 1, wherein:
the partitioning member is constituted by a self lubricating rubber material.

8. A fuel container for fuel cells as defined in claim 1, wherein:
the extruding means is compressed gas; and
the extruding means housing chamber is a compressed gas chamber, in which the compressed gas is sealed.

9. A fuel container for fuel cells as defined in claim 8, wherein:
a coating layer having non-eluting properties with respect to the liquid fuel is provided on at least one of the surfaces of the connector main body and the partitioning member which are in sliding contact.

10. A fuel container for fuel cells as defined in claim 9, wherein:
the coating layer is constituted by a polyparaxylene resin.

11. A fuel container for fuel cells as defined in claim 10, wherein the polyparaxylene resin is a parylene N represented by the following chemical formula (I):

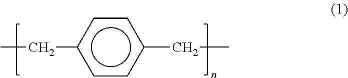

12. A fuel container for fuel cells as defined in claim 1, wherein the container main body comprises:
a cylindrical outer container; and
a cylindrical inner container that communicates with the connecting port, and with which the partitioning member is in slidable contact, provided within the outer container in a double container structure.

13. A fuel container for fuel cells as defined in claim 12, wherein:
a coating layer having non-eluting properties with respect to the liquid fuel is provided on at least one of the surfaces of the connector main body and the partitioning member which are in sliding contact.

14. A fuel container for fuel cells as defined in claim 13, wherein:
the coating layer is constituted by a polyparaxylene resin.

15. A fuel container for fuel cells as defined in claim 14, wherein:
the film thickness of the coating layer is within a range of 0.2 μm to 3 μm.

16. A fuel container for fuel cells as defined in claim 14, wherein the polyparaxylene resin is a parylene N represented by the following chemical formula (I):

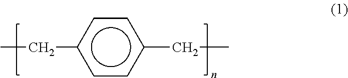

17. A fuel container for fuel cells as defined in claim 12, wherein:
the partitioning member is constituted by a self lubricating rubber.

18. A fuel container for fuel cells as defined in claim 12, wherein:
the extruding means is compressed gas; and
the extruding means housing chamber is a compressed gas chamber, in which the compressed gas is sealed.

19. A fuel container for fuel cells as defined in claim 18, wherein:
a coating layer having non-eluting properties with respect to the liquid fuel is provided on at least one of the surfaces of the connector main body and the partitioning member which are in sliding contact.

20. A fuel container for fuel cells as defined in claim 19, wherein:
the coating layer is constituted by a polyparaxylene resin.

21. A fuel container for fuel cells as defined in claim 20, wherein the polyparaxylene resin is a parylene N represented by the following chemical formula (I): [chemical structure]
